(19) United States
(12) Patent Application Publication
(10) Pub. No.: US 2003/0050833 A1
(43) Pub. Date: Mar. 13, 2003

(54) Monitoring actual screen display of online advertising

(75) Inventors: Mark Joseph Hamzy, Round Rock, TX (US); Rabindranath Dutta, Austin, TX (US)

Correspondence Address: BIGGERS & OHANIAN, PLLC, 5 SCARLET RIDGE, AUSTIN, TX, 78737, US

(73) Assignee: INTERNATIONAL BUSINESS MACHINES CORPORATION, ARMONK, NY

(21) Appl. No.: 09/941,248

(22) Filed: Aug. 28, 2001

(51) Int. Cl. G06F 17/60

(52) U.S. Cl. 705/14

(57) ABSTRACT

Online advertising including storing in computer memory an advertisement display image assigned for display at a screen display location during a display period; displaying the advertisement display image at the screen display location during the display period; confirming, at a confirmation time during the display period, the displaying of the advertisement display image at the screen display location, wherein the confirming results in a determination whether the advertisement display image is fully displayed at the screen display location at the confirmation time; and recording in computer memory the determination whether the advertisement display image is fully displayed at the screen display location at the confirmation time.

### BACKGROUND OF THE INVENTION

1. Field of the Invention

The invention relates generally to online advertising and in particular to an improved method of monitoring actual screen display time for advertisements.

2. Description Of Related Art

Pay-per view, whereby an online advertiser pays a Web server site depending on the number of downloads to a Web client of an advertisement is the most widely-used paradigm of e-commerce advertising. The method is used by many merchants and web advertisers. Nevertheless what matters to advertisers most is not that a person has clicked but that he has actually seen the ad on the screen. Often filters and other mechanisms in browsers and proxies can be configured to eliminate content being shown on a screen even after it is downloaded. For example, the Junkbuster.com proxy can eliminate ads by maintaining a list of blocked advertiser sites for download such as blocking downloads from doubleclick.com, valueclick.com, and other services. Proxies are sometimes tailored to download but not display advertisements on the screen.

In the model of the contemporary Web, however, advertising sustains the content for most of the major sites. Hence there is an enormous commercial interest in tracking what a user actually sees on the screen. A parallel in the TV world would make the problem clear. For years Nilssen ratings rated TV viewership numbers by attaching extra hardware to TV sets that monitors the channel the TV set was tuned to while it was on, and kept record of it. Unfortunately when people started leaving their TV sets on all the time in the living room without being actually present the scheme started providing erroneous data thereby distorting the results. With billions of advertising revenues at stake proper accounting of what is actually seen or heard by the user is a very lucrative business. In the area of the Web this is also likely to be so and already sites such as Mediamatrix.com have already made a name for themselves by developing methods of accounting for actual viewing of Web sites.

Prior art schemes of free net access in exchange for advertisement viewing has made possible the download of specialized software to the Web client, such as, for example, Altavista, Netzero, Yahoo-KMart's Bluelight, and so on. Generally such programs monitor URL clicks and site accesses. There are caveats stating that the program cannot be modified, but the nature of the Web makes it very easy to filter content according to one's wishes via proxies, redirecting output, and other means, even without modifying the downloaded program. In any case, simple banner ads on the Web are typically sent to unmodified browsers such as the IE5 or Netscape browser and they are very susceptible to tampering. In fact, Junkbuster.com affiliated itself with a startup company to eliminate ads altogether from the viewer's screen. Microsoft also is creating enhancements to browsers that will disable cookies to be sent to sites other than the URL address domain of the parent documents. Generally, the backlash against Web ads is creating technological barriers to ads flowing to the end-user.

In view of the circumstances just described, it is clear that there is an ongoing need in the art for improved methods of determining that advertising intended for display on users' screens is in fact actually displayed on users' screens.

### SUMMARY OF THE INVENTION

Typical embodiments of the invention include methods of online advertising including storing in computer memory an advertisement display image assigned for display at a screen display location during a display period and displaying the advertisement display image at the screen display location during the display period. Typical embodiments also include confirming, at a confirmation time during the display period, the displaying of the advertisement display image at the screen display location, wherein the confirming results in a determination whether the advertisement display image is fully displayed at the screen display location at the confirmation time; and recording in computer memory the determination whether the advertisement display image is fully displayed at the screen display location at the confirmation time.

Typical embodiments of the invention also include periodically repeating the steps of confirming the displaying of the advertisement display image and recording in computer memory the determination whether the advertisement display image is fully displayed at the screen display location at the confirmation time. Typical embodiments further include calculating an amount to be charged for advertising in dependence upon the determination whether the advertisement display image is fully displayed at the screen display location at the confirmation time.

In typical embodiments of the invention confirming the displaying of the advertisement display image include intercepting a call to a bitblt routine; retrieving a bitmapped image ordered for display by the intercepted call; and comparing the retrieved bitmapped image and the advertisement display image. In typical embodiments, the comparing of the retrieved bitmapped image and the advertisement display image includes comparing only a portion of the identified bitmapped image and a corresponding portion of the advertisement display image.

In typical embodiments of the invention confirming the displaying of the advertisement display image further includes retrieving from computer display memory a bitmapped image displayed at the screen display location at the confirmation time; and comparing the retrieved bitmapped image and the advertisement display image. In typical embodiments the comparing of the retrieved bitmapped image and the advertisement display image includes comparing only a portion of the identified bitmapped image and a corresponding portion of the advertisement display image.

Typical embodiments of the invention further include confirming the displaying of the advertisement display image at the screen display location results in a determination that the advertisement display image is only partially displayed at the screen display location at the confirmation time, and recording in computer memory the determination whether the advertisement display image is fully displayed at the screen display location at the confirmation time includes recording in computer memory the determination that the advertisement display image is only partially displayed at the screen display location at the confirmation time. Typical embodiments also include calculating an amount to be charged for advertising in dependence upon the determination that the advertisement display image is only partially displayed at the screen display location at the confirmation time.

In addition to the method aspects of the invention, further aspects of the invention include embodiments as computer systems and computer program products. The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a control flow diagram illustrating typical embodiments of the invention.

FIG. 2 is a more detailed control flow diagram illustrating more detailed embodiments of a confirmation step.

FIG. 3 is a more detailed control flow diagram illustrating alternative embodiments of a confirmation step.

FIG. 4 is an illustration of data structures useful in various embodiments of the invention.

FIGS. 5a, 5b, 5c, and 5d illustrated an example embodiment of confirming display of an advertisement display image.

### DETAILED DESCRIPTION OF EXEMPLARY EMBODIMENTS

### Introduction

The present invention is described to a large extent in this specification in terms of methods of online advertising, particularly methods of monitoring display time for advertisements. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory data elements and programmed steps of the method of the invention for execution by a processing unit as computer program instructions, which computer memory includes electronic circuits configured to store data and program instructions. The invention also is embodied in a computer program product, such as a diskette or other recording medium, for use with any suitable data processing system.

Embodiments of a computer program product typically are implemented by use of any recording media for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the terms “field,”. “data element,” and “attribute” are used as synonyms, referring to individual elements of digital data. Aggregates of data elements are referred to as “records” or “data structures.” Definitions of complex data structures that include member methods, functions, or software routines in addition to data elements are referred to as “classes.” Instances of complex data structures are referred to as “objects” or “class objects.”

“Bitblt” refers to a family of closely related, well-known, algorithms for moving and copying rectangles of bits between main and display memory on a bit-mapped device, or between two areas of either main or display memory. Standard bitblt( ) routines are supported, for example, in standard programming libraries, including C and C++ graphics libraries, and have been so supported for many years.

“Client” means any device capable of accessing a server or a web site through a network. Examples of clients are hand-held personal computers, special purpose devices that are network enabled, internet-capable personal data organizers, and others that will occur to those of skill in the art. Various embodiments of clients are capable of wired and/or wireless network access. The use as a client device of any instrument capable of accessing a server through a network is well within the present invention.

A “browser” is a software application typically installed and running upon a client device, the browser operating to download to the client device from a web server documents developed in a markup language, display the contents of the documents, and to the extent that the documents include tags identifying other documents to download or other actions to be taken, downloading the documents or taking the actions.

“Coupled for data communications” means any form of data communications, wireless, infrared, radio, internet protocols, HTTP protocols, email protocols, networked connections, direct connections, dedicated phone lines, dial-ups, and other forms of data communications as will occur to those of skill in the art. The phrases “coupled for data communications” and “connected for data communications” are used synonymously in this specification.

The term “network” is used in this specification to mean any networked coupling for data communications. Examples of networks useful with the invention include wireless networks, intranets, extranets, internets, local area networks, wide area networks, and other network arrangements as will occur to those of skill in the art. The use of any networked coupling from clients to one or more merchant web sites is well within the scope of the present invention.

“URL” means Uniform Resource Locator, the standard method of associating world wide web data locations with network addresses for data communications. Typical forms of URL include web site address, that is, a network address or a domain name that resolves to a network address identifying a particular computer or other resource on an internet. Typical forms of URL include also a location within a file structure or subdirectory location where files, documents, programs, or other data is located on the computer or other resource identified by the network address or domain name.

“World Wide Web,” or more simply “the web,” refers to the well-known system of internet protocol (“IP”) servers that support specially formatted documents, documents formatted in HTML (“HyperText Markup Language”), XML (“Extended Markup Language”), or other languages. The term “web” is used in this specification also to refer to any server or connected group or interconnected groups of servers that implement the HyperText Transport Protocol, “HTTP,” regardless whether such servers or groups of servers are coupled to the world wide web as such.

### DETAILED DESCRIPTION

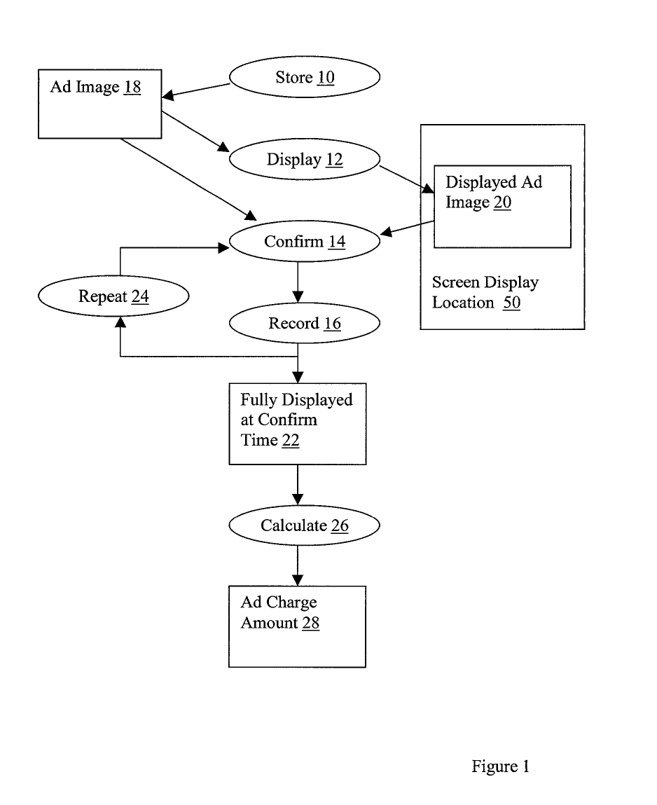

Typical embodiments of the invention, as shown in FIG. 1, include methods of online advertising. In typical embodiments online advertising includes storing (10) in computer memory an advertisement display image (18) assigned for display at a screen display location (50) during a display period and displaying (12) the advertisement display image (20) at the screen display location (50) during the display period. Typical embodiments also include confirming (14), at a confirmation time during the display period, the displaying of the advertisement display image at the screen display location (50). In typical embodiments, the confirming results in a determination (22) whether the advertisement display image is fully displayed at the screen display location (50) at the confirmation time. Typical embodiments further include recording (16) in computer memory the determination (22) whether the advertisement display image is fully displayed at the screen display location (50) at the confirmation time.

Typical embodiments of the kind illustrated in FIG. 1 include periodically repeating (24) the steps of confirming the displaying of the advertisement display image and recording in computer memory the determination whether the advertisement display image is fully displayed at the screen display location (50) at the confirmation time.

Typical embodiments further include calculating (26) an amount to be charged for advertising in dependence upon the determination (22) whether the advertisement display image is fully displayed at the screen display location (50) at the confirmation time.

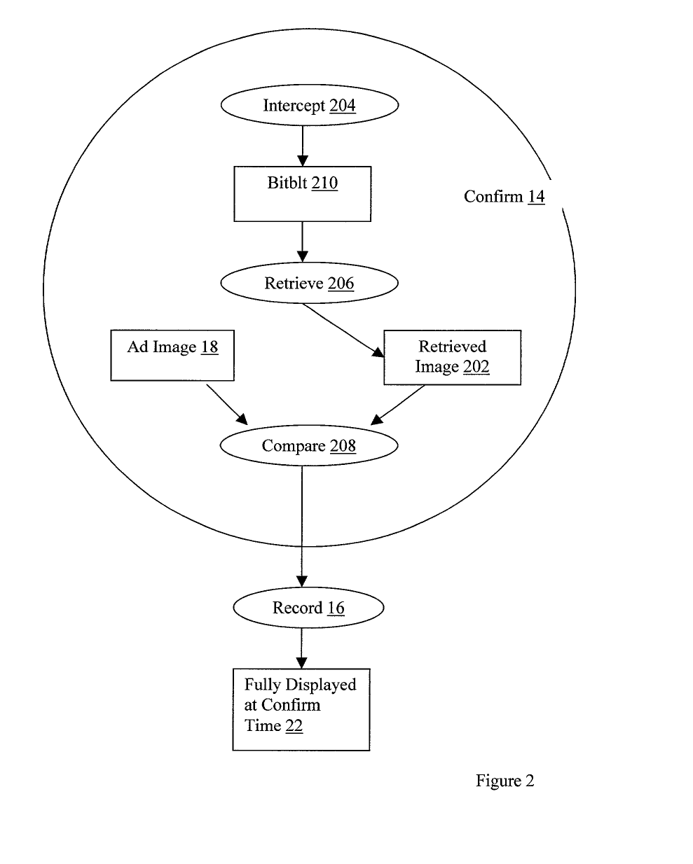

Turning now to FIG. 2, typical embodiments of the invention as illustrated as including confirming (14) the displaying of the advertisement display image (18), which further comprises intercepting (204) a call to a bitblt routine (210); retrieving (206) a bitmapped image (202) ordered for display by the intercepted call; and comparing (208) the retrieved bitmapped image (202) and the advertisement display image (18). In some embodiments the comparing (208) of the retrieved bitmapped image (202) and the advertisement display image (18) includes comparing only a portion of the identified bitmapped image and a corresponding portion of the advertisement display image.

Intercepting calls to bitblt routines, in some exemplary embodiments, is implemented by writing a separate bitblt routine and compiling it ahead of the standard bitblt in a run time calling hierarchy. Other embodiments implement intercepting calls to bitblt routines by inserting a call to a custom routine as the first line of code in the source code for the standard bitblt( ) and then recompiling bitblt itself. In other example embodiments, a macro named ‘bitblt( )’ is added to the C header file <graphics.h>, the macro written so as to first call a custom routine and then call the regular bitblt( ). Other ways of intercepting calls to bitblt routines will occur to those of skill in the art, all such ways being well within the scope of the present invention.

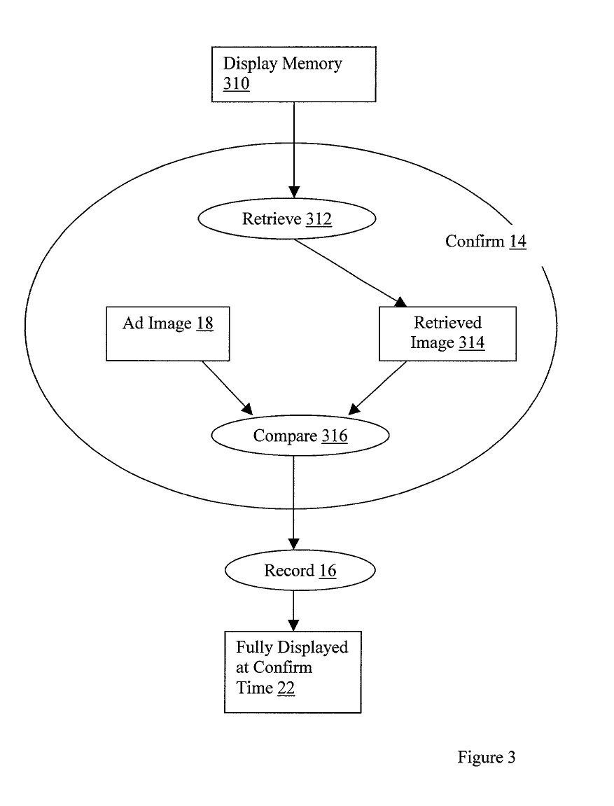

In some exemplary embodiments of the invention, as shown in FIG. 3, confirming (14) the displaying of the advertisement display image (18) further includes retrieving (312) from computer display memory (310) a bitmapped image (314) of a current display screen and scanning the bitmapped image for the advertisement display image. In some embodiments, scanning the bitmapped image of a current screen display for the advertisement display image includes searching for a logo or other key sub-image contained within a class or group of advertisement display images and synchronizing the image comparison in dependence upon the logo or other key sub-image.

In many more specific example embodiments of the invention, as illustrated in FIG. 3, confirming (14) the displaying of the advertisement display image (18) further includes retrieving (312) from computer display memory (310) a bitmapped image (314) displayed at the screen display location (50) at the confirmation time; and comparing (316) the retrieved bitmapped image (314) and the advertisement display image (18). In typical embodiments the comparing (316) of the retrieved bitmapped image (314) and the advertisement display image (18) includes only a portion of the identified bitmapped image and a corresponding portion of the advertisement display image.

In some embodiments, confirming the displaying of the advertisement display image includes adding HTML tags that demarcate advertisements. More specifically, in such embodiments, HTML tags are added as illustrated in the following pseudocode:

<!-- begin report detailed showing -->

<IMG src=“http://www.advertisement.com/ad001.jpg”>

<!-- end report detailed showing -->

Or, alternatively:

<detailed_ad>

<IMG src=“http://www.advertisement.com/ad001.jpg”>

</detailed_ad>

These pseudocode examples just above are two ways of using HTML tags to notify a browser to track an advertisement. Other ways of modifying HTML tags to so notify a browser will occur to those of skill in the art, all such ways being well within the scope of the present invention.

In such embodiments, the browser is modified to recognize new tags advising the browser to track an advertisement. The browser then carries out image retrieval and image comparison as described and records display records. Alternatively, the browser transmits display records including confirmation times, or start times and stop times for ad displays, and the portion of an ad that was visible, to an ad server.

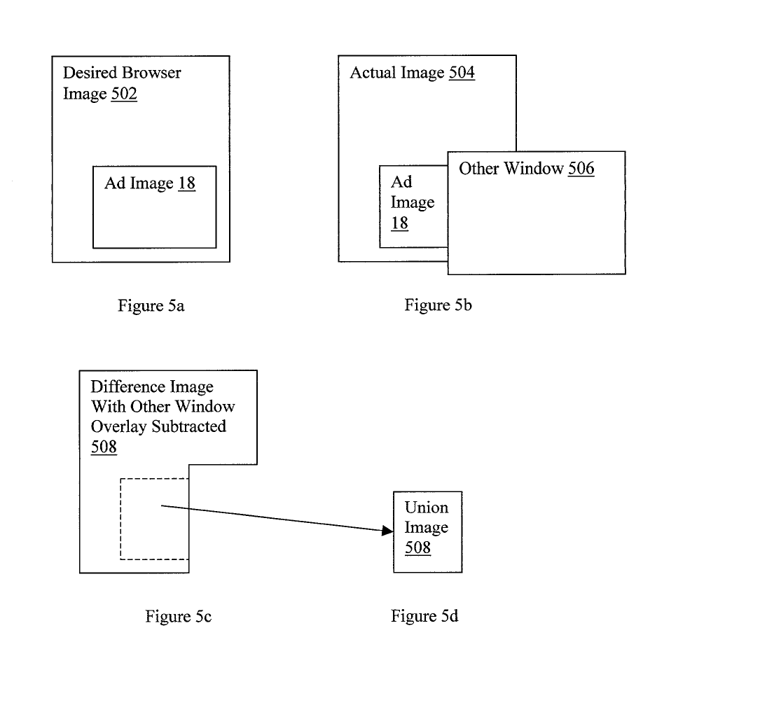

Some embodiments carry out image comparison by monitoring through the browser the windows that are shown on a user's screen and calculating the visible percentage of an ad from information regarding actual windows displayed. More specifically, such embodiments operate as illustrated in FIGS. 5a-5d. Such embodiments begin with a stored advertisement display image (18) and a known desired browser image (502). Such embodiments then typically use bitblt calls to retrieve the browser window's actual size and position on the display, including actual overlays from other windows (504), as shown in FIG. 5b. To the extent that the actual browser window is overlain by other windows, such embodiments typically subtract from the browser image the graphic overlays of other windows to generate a difference image as shown in FIG. 5c. Then such embodiments typically take the union of the difference image (508) and the advertisement display image (18) to derive a union image (508). The size of the union image (508) compared to the size of the advertisement display image (18) gives the portion of the advertisement display image actually displayed at a confirmation time.

In typical embodiments of the kind illustrated in FIG. 1 confirming (14) the displaying of the advertisement display image (18) at the screen display location (50) results in a determination that the advertisement display image is only partially displayed at the screen display location (50) at the confirmation time and recording (16) in computer memory the determination (22) whether the advertisement display image (18) is fully displayed at the screen display location (50) at the confirmation time includes recording in computer memory the determination that the advertisement display image is only partially displayed at the screen display location (50) at the confirmation time. Typical embodiments further include calculating (26) an amount to be charged for advertising in dependence upon the determination (22) that the advertisement display image (18) is only partially displayed at the screen display location (50) at the confirmation time.

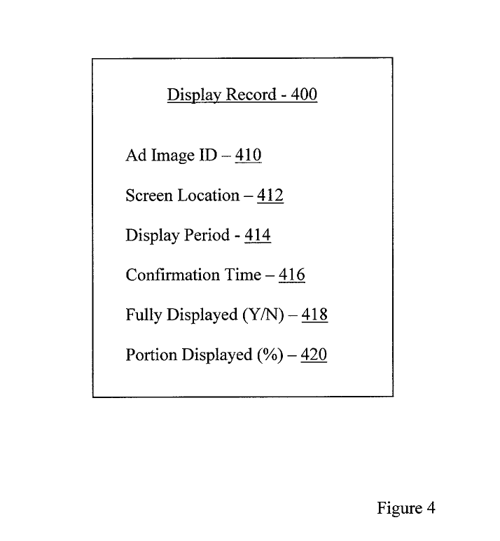

More particularly, many embodiments record computer records (400) of displays of advertisement display images as illustrated by the example data structure in FIG. 4. As shown in FIG. 4, some embodiments record identification codes for particular advertisement display images (410) along with a screen location (412), a display period (414), a confirmation time (414) when the display was checked, and a field indicating whether the advertisement display image in question was fully displayed. Many embodiments use the several fields just mentioned, for example, to infer from a series of such records, that is, a series of recorded indications of display at a series of confirmation times within a display period, to infer the proportion of the display period in which the subject advertisement display image was fully displayed. Embodiments of this kind typically calculate amounts to be charged for advertising on the basis of the proportion of the display period in which a subject advertisement display image was fully displayed.

Further embodiments, as shown also on FIG. 4, include a measure of the portion of the advertisement display image displayed (420) at any particular confirmation time (416). Embodiments of this kind typically calculate amounts to be charged for advertising on the basis of the portion of the advertisement display image actually displayed (420) at a series of confirmation times (416) during a display period (414).

FIG. 2 is useful also to illustrate a further embodiment of the invention in which confirming (14) the displaying of the advertisement display image includes retrieving (312) from computer display memory, by use of operating system calls, a bitmapped image of an entire computer display screen upon which is displayed at least a portion of the advertisement display image. More specifically, retrieving a bitmapped image of an entire computer display screen by use of operating system calls is carried out in some embodiments as illustrated by the following example pseudocode:

hwnd=GetDesktopWindow ( );

hdc=GetWindowDC (hwnd);

GetWindowRect (hwnd, &rect);

hdcMem=CreateCompatibleBitmap (NULL);

iWidth=rect.right−rect.left;

iHeight=rect.bottom−rect.top;

hBmp=CreateCompatibleBitmap (hdc, iWidth, iHeight);

BitBlt (hdcMem, 0, 0, iWidth, iHeight, hdc, 0, 0, SRCCOPY);

hOld=SelectObject (hdcMem, hBmp);

cbBits=((24*iWidth+31)/32* 4)*iHeight;

pbBits=malloc (cbBits);

GetBitmapBits (hBmp, cbBits, pbBits);//Look at bits

Such exemplary embodiments typically include finding (not shown) within the bitmapped image of an entire computer display screen, a bitmapped signature, wherein the bitmapped signature is contained also in the advertisement display image. A bitmapped signature is any recognizable sequence or pattern of bitmapped pixels, such as, for example, a logo, trademark, service mark, or a special identification sequence or pattern fashioned particularly for the purpose of confirming advertisement displays.

Such exemplary embodiments typically include mapping (not shown), in dependence upon the bitmapped signature, a correspondence among pixels in the advertisement display image and pixels in the bitmapped image of an entire computer display screen. Mapping a correspondence in some embodiments includes writing corresponding pixels from both images to storage locations in arrays having the same indices for corresponding pixels. Other useful methods of mapping correspondence among pixels in an advertisement display image and corresponding pixels in a bitmapped image of an entire computer display screen will occur to those of skill in the art, and all such methods are well within the scope of the present invention.

Typical exemplary embodiments of this kind, using bitmapped images of an entire computer display screen, include determining a portion of the advertisement display image that is actually displayed, a step which is often carried out by comparing pixel-by-pixel the pixels of the advertisement display image and corresponding pixels of the bitmapped image of an entire computer display screen. In addition, some exemplary embodiments of this kind include determining a portion of the advertisement display image that is actually displayed by comparing pixel-by-pixel only a comparison portion of the pixels of the advertisement display image and corresponding pixels of the bitmapped image of an entire computer display screen, the comparison portion being a sufficient number of pixels to support a statistically reliable determination of the portion of the advertisement display image that is actually displayed.

It will be understood from the foregoing description that various modifications and changes may be made in the many embodiments of the present invention without departing from the true spirit of the invention. It is intended that the descriptions in this specification are for purposes of illustration only and are not to be construed in a limiting sense. The scope of the present invention is limited only by the language of the following claims.

What is claimed is:

1. A method of online advertising comprising the steps of:
storing in computer memory an advertisement display image assigned for display at a screen display location during a display period;
displaying the advertisement display image at the screen display location during the display period;
confirming, at a confirmation time during the display period, the displaying of the advertisement display image at the screen display location, wherein the confirming results in a determination whether the advertisement display image is fully displayed at the screen display location at the confirmation time; and
recording in computer memory the determination whether the advertisement display image is fully displayed at the screen display location at the confirmation time.

2. The method of claim 1 further comprising periodically repeating the steps of confirming the displaying of the advertisement display image and recording in computer memory the determination whether the advertisement display image is fully displayed at the screen display location at the confirmation time.

3. The method of claim 1 further comprising calculating an amount to be charged for advertising in dependence upon the determination whether the advertisement display image is fully displayed at the screen display location at the confirmation time.

4. The method of claim 1 wherein confirming the displaying of the advertisement display image comprises the further steps of:
intercepting a call to a bitblt routine;
retrieving a bitmapped image ordered for display by the intercepted call; and
comparing the retrieved bitmapped image and the advertisement display image.

5. The method of claim 4 wherein the comparing of the retrieved bitmapped image and the advertisement display image comprises comparing only a portion of the identified bitmapped image and a corresponding portion of the advertisement display image.

6. The method of claim 1 wherein confirming the displaying of the advertisement display image comprises the further steps of:
retrieving from computer display memory a bitmapped image displayed at the screen display location at the confirmation time; and
comparing the retrieved bitmapped image and the advertisement display image.

7. The method of claim 6 wherein the comparing of the retrieved bitmapped image and the advertisement display image comprises comparing only a portion of the identified bitmapped image and a corresponding portion of the advertisement display image.

8. The method of claim 1 wherein
confirming the displaying of the advertisement display image at the screen display location in a determination that the advertisement display image is only partially displayed at the screen display location at the confirmation time; and
recording in computer memory the determination whether the advertisement display image is fully displayed at the screen display location at the confirmation time includes recording in computer memory the determination that the advertisement display image is only partially displayed at the screen display location at the confirmation time.

9. The method of claim 8 further comprising calculating an amount to be charged for advertising in dependence upon the determination that the advertisement display image is only partially displayed at the screen display location at the confirmation time.

10. The method of claim 1 wherein confirming the displaying of the advertisement display image comprises the further steps of:
retrieving from computer display memory, by use of operating system calls, a bitmapped image of an entire computer display screen upon which is displayed at least a portion of the advertisement display image;
finding, within the bitmapped image of an entire computer display screen, a bitmapped signature, wherein the bitmapped signature is contained also in the advertisement display image;
mapping, in dependence upon the bitmapped signature, a correspondence among pixels in the advertisement display image and pixels in the bitmapped image of an entire computer display screen; and
determining a portion of the advertisement display image that is actually displayed, further comprising comparing pixel-by-pixel the pixels of the advertisement display image and corresponding pixels of the bitmapped image of an entire computer display screen.

11. The method of claim 10 wherein determining a portion of the advertisement display image that is actually displayed is carried out by comparing pixel-by-pixel only a comparison portion of the pixels of the advertisement display image and corresponding pixels of the bitmapped image of an entire computer display screen, the comparison portion being a sufficient number of pixels to support a statistically reliable determination of the portion of the advertisement display image that is actually displayed.

12. A system of online advertising comprising:
means for storing in computer memory an advertisement display image assigned for display at a screen display location during a display period;
means for displaying the advertisement display image at the screen display location during the display period;
means for confirming, at a confirmation time during the display period, the displaying of the advertisement display image at the screen display location, wherein the confirming results in a determination whether the advertisement display image is fully displayed at the screen display location at the confirmation time; and
means for recording in computer memory the determination whether the advertisement display image is fully displayed at the screen display location at the confirmation time.

13. The system of claim 12 further comprising means for periodically repeating the steps of confirming the displaying of the advertisement display image and recording in computer memory the determination whether the advertisement display image is fully displayed at the screen display location at the confirmation time.

14. The system of claim 12 further comprising means for calculating an amount to be charged for advertising in dependence upon the determination whether the advertisement display image is fully displayed at the screen display location at the confirmation time.

15. The system of claim 12 wherein means for confirming the displaying of the advertisement display image further comprises:
means for intercepting a call to a bitblt routine;
means for retrieving a bitmapped image ordered for display by the intercepted call; and
means for comparing the retrieved bitmapped image and the advertisement display image.

16. The system of claim 15 wherein the means for comparing of the retrieved bitmapped image and the advertisement display image comprises means for comparing only a portion of the identified bitmapped image and a corresponding portion of the advertisement display image.

17. The system of claim 12 wherein means for confirming the displaying of the advertisement display image further comprises:
means for retrieving from computer display memory a bitmapped image displayed at the screen display location at the confirmation time; and
means for comparing the retrieved bitmapped image and the advertisement display image.

18. The system of claim 17 wherein the means for comparing of the retrieved bitmapped image and the advertisement display image comprises means for comparing only a portion of the identified bitmapped image and a corresponding portion of the advertisement display image.

19. The system of claim 12 wherein
means for confirming the displaying of the advertisement display image at the screen display location in a determination that the advertisement display image is only partially displayed at the screen display location at the confirmation time; and
means for recording in computer memory the determination whether the advertisement display image is fully displayed at the screen display location at the confirmation time includes means for recording in computer memory the determination that the advertisement display image is only partially displayed at the screen display location at the confirmation time.

20. The system of claim 19 further comprising means for calculating an amount to be charged for advertising in dependence upon the determination that the advertisement display image is only partially displayed at the screen display location at the confirmation time.

21. The system of claim 12 wherein means for confirming the displaying of the advertisement display image further comprises:
means for retrieving from computer display memory, by use of operating system calls, a bitmapped image of an entire computer display screen upon which is displayed at least a portion of the advertisement display image;
means for finding, within the bitmapped image of an entire computer display screen, a bitmapped signature, wherein the bitmapped signature is contained also in the advertisement display image;
means for mapping, in dependence upon the bitmapped signature, a correspondence among pixels in the advertisement display image and pixels in the bitmapped image of an entire computer display screen; and
means for determining a portion of the advertisement display image that is actually displayed, further means for comprising comparing pixel-by-pixel the pixels of the advertisement display image and corresponding pixels of the bitmapped image of an entire computer display screen.

22. The method of claim 21 wherein means for determining a portion of the advertisement display image that is actually displayed is implemented by use of means for comparing pixel-by-pixel only a comparison portion of the pixels of the advertisement display image and corresponding pixels of the bitmapped image of an entire computer display screen, the comparison portion being a sufficient number of pixels to support a statistically reliable determination of the portion of the advertisement display image that is actually displayed.

23. A computer product program of online advertising comprising:
a recording medium;
means, recorded on the recording medium, for storing in computer memory an advertisement display image assigned for display at a screen display location during a display period;
means, recorded on the recording medium, for displaying the advertisement display image at the screen display location during the display period;
means, recorded on the recording medium, for confirming, at a confirmation time during the display period, the displaying of the advertisement display image at the screen display location, wherein the confirming results in a determination whether the advertisement display image is fully displayed at the screen display location at the confirmation time; and
means, recorded on the recording medium, for recording in computer memory the determination whether the advertisement display image is fully displayed at the screen display location at the confirmation time.

24. The computer product program of claim 23 further comprising means, recorded on the recording medium, for periodically repeating the steps of confirming the displaying of the advertisement display image and recording in computer memory the determination whether the advertisement display image is fully displayed at the screen display location at the confirmation time.

25. The computer product program of claim 23 further comprising means, recorded on the recording medium, for calculating an amount to be charged for advertising in dependence upon the determination whether the advertisement display image is fully displayed at the screen display location at the confirmation time.

26. The computer product program of claim 23 wherein means, recorded on the recording medium, for confirming the displaying of the advertisement display image further comprises:
means, recorded on the recording medium, for intercepting a call to a bitblt routine;
means, recorded on the recording medium, for retrieving a bitmapped image ordered for display by the intercepted call; and
means, recorded on the recording medium, for comparing the retrieved bitmapped image and the advertisement display image.

27. The computer product program of claim 26 wherein the means, recorded on the recording medium, for comparing of the retrieved bitmapped image and the advertisement display image comprises means, recorded on the recording medium, for comparing only a portion of the identified bitmapped image and a corresponding portion of the advertisement display image.

28. The computer product program of claim 23 wherein means, recorded on the recording medium, for confirming the displaying of the advertisement display image further comprises:
means, recorded on the recording medium, for retrieving from computer display memory a bitmapped image displayed at the screen display location at the confirmation time; and
means, recorded on the recording medium, for comparing the retrieved bitmapped image and the advertisement display image.

29. The computer product program of claim 28 wherein the means, recorded on the recording medium, for comparing of the retrieved bitmapped image and the advertisement display image comprises means, recorded on the recording medium, for comparing only a portion of the identified bitmapped image and a corresponding portion of the advertisement display image.

30. The computer product program of claim 23 wherein
means, recorded on the recording medium, for confirming the displaying of the advertisement display image at the screen display location in a determination that the advertisement display image is only partially displayed at the screen display location at the confirmation time; and
means, recorded on the recording medium, for recording in computer memory the determination whether the advertisement display image is fully displayed at the screen display location at the confirmation time includes means, recorded on the recording medium, for recording in computer memory the determination that the advertisement display image is only partially displayed at the screen display location at the confirmation time.

31. The computer product program of claim 30 further comprising means, recorded on the recording medium, for calculating an amount to be charged for advertising in dependence upon the determination that the advertisement display image is only partially displayed at the screen display location at the confirmation time.

32. The computer product program of claim 23 wherein means, recorded on the recording medium, for confirming the displaying of the advertisement display image further comprises:
means, recorded on the recording medium, for retrieving from computer display memory, by use of operating system calls, a bitmapped image of an entire computer display screen upon which is displayed at least a portion of the advertisement display image;
means, recorded on the recording medium, for finding, within the bitmapped image of an entire computer display screen, a bitmapped signature, wherein the bitmapped signature is contained also in the advertisement display image;
means, recorded on the recording medium, for mapping, in dependence upon the bitmapped signature, a correspondence among pixels in the advertisement display image and pixels in the bitmapped image of an entire computer display screen; and
means, recorded on the recording medium, for determining a portion of the advertisement display image that is actually displayed, further comprising means for comprising comparing pixel-by-pixel the pixels of the advertisement display image and corresponding pixels of the bitmapped image of an entire computer display screen.

33. The method of claim 32 wherein means for determining a portion of the advertisement display image that is actually displayed is implemented by use of means, recorded on the recording medium, for comparing pixel-by-pixel only a comparison portion of the pixels of the advertisement display image and corresponding pixels of the bitmapped image of an entire computer display screen, the comparison portion being a sufficient number of pixels to support a statistically reliable determination of the portion of the advertisement display image that is actually displayed.
